(19) United States
(12) Patent Application Publication
(10) Pub. No.: US 2009/0104076 A1
(43) Pub. Date: Apr. 23, 2009

(54) SAMPLE PREPARATION CARTRIDGE AND SYSTEM

(75) Inventor: Torsten Albert Staab, Los Alamos, NM (US)

Correspondence Address: JOHN P. O'BANION;O'BANION & RITCHEY LLP, 400 CAPITOL MALL SUITE 1550, SACRAMENTO, CA, 95814, US

(73) Assignee: LOS ALAMOS NATIONAL SECURITY LLC, Los Alamos, NM (US)

(21) Appl. No.: 11/875,702

(22) Filed: Oct. 19, 2007

(51) Int. Cl. B01J 19/00

(52) U.S. Cl. 422/68.1

(57) ABSTRACT

A modular specimen preparation cartridge with a tubular body with the interior segmented by pressure sensitive membranes that will rupture or open when exposed to a threshold pressure forming a sequence of chambers. Bladders or capsules filled with reagents or other fluids that will release the contents of the capsules under applied pressure are contained in the chambers. Filters, temperature control elements, diagnostic test strips, or catalysts may also be in the chambers. The cartridge may be adapted to virtually any sample preparation and/or analysis protocols or to sample type. The cartridge may also be modular and capable of being coupled to other cartridges or storage containers. In one embodiment, the tubular body is compressible and external pressure causes the capsules to rupture releasing the contents into the chamber. In another embodiment, pressure is applied to membranes and reagent capsules through the use of a plunger advancing though the center of the body.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention pertains generally to diagnostic analysis of organic and inorganic specimens, and more particularly to a self-contained sample preparation and/or analysis cartridge that can provide linear processing of samples in the field or at a point of care setting as well as stabilize samples for further analysis in a laboratory with a minimum potential for sample and user contamination.

2. Description of Related Art

Technological advancements in the field of proteomics, genomics, immunology, medicine and environmental science have greatly expanded the number of diagnostic and analytical procedures that are available to researchers, government officials and health care practitioners. Many of the analytical capabilities previously confined to the laboratory have been brought to the field to provide real time results at the site of specimen collection. Some of the high costs and high levels of technical expertise that are needed for laboratory analyses have been eliminated through standardization and optimized protocols and kits.

The success of many diagnostic procedures and methods depends, in part, upon the preparation and quality of an acquired specimen. Improper sampling protocols and sample preparation can result in a loss of sample integrity, contamination, inconclusive results, false positives or poor yields.

In proteomics, for example, sample preparation is becoming particularly critical in the case of high throughput techniques where the required conditions of a sample in one stage may directly conflict with the conditions needed in a second stage. The influence on the efficiency and precision of downstream analytical methods by sample preparation can be illustrated with the case of adipose tissue proteins. Strong detergents that are used to dissolve membrane lipids will often interfere with analytical methods such as gel electrophoresis, mass spectrometry and liquid chromatography. Consequently, poor protein extraction techniques may produce poor results and hinder discovery of proteins and ultimately limit the understanding of biological or physiological processes that are being investigated.

Similarly, recent advances in analytical techniques of isolation, manipulation and analysis of nucleic acids have created new tools for academic research, forensics and medical diagnosis. The initial preparation steps with a nucleic acid sample can be critical to the success of the subsequent analytical procedures. For example, Polymerase Chain Reaction or PCR, is a powerful DNA replication system that allows the selective amplification of target DNA sequences. Target sequences can be replicated many times over in a period of a few hours to produce a significant quantity of material for analysis. PCR can be used to amplify very small sample quantities of DNA or degraded samples of DNA for analysis. In many instances, PCR has provided conclusive identifications of individuals in cases where conventional DNA typing was inconclusive or ineffective.

Although the ability of DNA to provide information for forensics and human identification is powerful, modern DNA sample analysis techniques that allow the amplification and analysis of minute amounts of DNA are prone to contamination and, consequently, misidentification. For example, contamination from spurious DNA or even very small amounts of DNA that are left over from previous amplifications can be re-amplified in the current PCR run. Two target DNA segments from contamination in PCR can lead to incorrect or inconclusive results.

Accurate and reliable analytical procedures of biological material are particularly important in forensics because of the significance of the use of the results. For example, the analysis of samples of blood, semen, other body fluids and similar biological evidence has become an essential tool for law enforcement investigators who are attempting to identify an individual who has perpetrated a violent crime. Biological evidence may be the only evidence that ties a suspect to a particular crime or that clears an innocent suspect of a crime. A composite of pieces of forensic evidence permit a reliable reconstruction of a crime and the activities of the participants in the crime as well as the victim. Some of the most crucial pieces of evidence that are gathered during a criminal investigation include biological evidence from samples containing blood, fibers, hair, and semen.

For example, if a sample of blood or DNA collected from a crime scene matches that of a reference sample taken from a particular suspect, the sample can be used as one piece of evidence to directly link the suspect to the scene of the crime. Likewise, if the DNA or blood of the reference sample of the suspect does not match that taken from the crime scene then the suspect may be ruled out as a suspect.

Contamination of a sample can come from many different sources and the possibility of contamination increases with handling. The introduction of foreign proteins, damaging chemicals or cross-contamination between collected sample and reference samples can occur with some frequency. The passage of time and the presence of contaminants in samples can lead to sample degradation, alter experimental results and can even cause damage to equipment.

Accordingly, the results of any analytical procedure may only be as good as the sample preparation techniques that are utilized. Sample preparation steps are therefore critical to the success of advanced molecular analytical techniques.

Another problem found with existing preparation systems is the need for sophisticated instruments that cannot be readily taken to the field or place of sample collection. Providing electrical power to sensitive instruments cannot be reasonably accomplished in the field. In addition, sophisticated lab technicians are required to operate such instruments essentially eliminating DNA-based health diagnostics tests that can be performed at home. A normal home user would not have the skills or auxiliary equipment necessary to perform such tests.

There is a need for an apparatus and method that will prepare samples for many different analytical techniques that reduces exposure to contaminants and is easily transportable. The present invention satisfies these needs, as well as others, and is generally an improvement over the art.

### BRIEF SUMMARY OF THE INVENTION

A self-contained modular sample preparation and/or analysis cartridge is provided for stabilization and processing of inorganic or organic samples. The sample preparation cartridge greatly reduces the potential for contamination or for confusion or loss of a sample during preparation steps. Sample degradation can also be avoided, because the cartridge is readily transportable to the location of sample collection and processing can take place at the time of collection rather than waiting for delivery to a laboratory before processing the sample. Use of the apparatus does not require any specialized skill or knowledge and provides consistent predictable results.

The sample preparation and analysis cartridge can also be adapted to prepare many different types of samples, perform in-situ sample analysis, and prepare samples for subsequent analysis by many different types of analytical procedures. In addition, the cartridge can be adapted to provide diagnostic functions, such as early identification of hazardous components in a field sample, identification of bacterial pathogens from medical research, food and environmental origins, as well as “yes” or “no” immunochemical responses using antibodies. The sample preparation cartridge is particularly suited for preparation schemes that have sequential steps and utilize fluid reagents.

One embodiment of the sample preparation and/or analysis cartridge according to the present invention has a tubular body preferably made from a flexible, deformable, disposable tube (either as one piece or made from interconnected segments). Depending on the respective sample preparation protocol, the tube may be subdivided into multiple, individual chambers or segments. These reaction chambers are separated by thin-walled, burstable (i.e., pressure-sensitive) plastic membranes.

Each chamber or preparation stage can include many different types of components, such as filter units, micro beads, floating piercing pins, and/or sample preparation reagents, such as lysis buffers, etc. depending on the sample preparation protocol.

The sample preparation solutions, for example, may be encapsulated in separate, breakable/burstable plastic bladders or glass capsules, vials, or tubes or bladders with one way pressure sensitive valves. The contents of these reagent containers can be a solid, particulate, liquid or gas. The amount or volume that is needed for a specific sample preparation step will be determined by the protocol that is selected and therefore the size and shape of these pre-packaged, ready-to-use solution reagent packets can vary. To control when and where in the tube certain bio-chemical reactions take place, these reagent containers are strategically placed inside the tube chambers or segments as dictated by the specific sample preparation protocol.

In use, sample collection media (e.g., a cotton bud or filter paper) is placed in the end of the deformable tube into the first chamber and sealed off. Pressure is progressively applied to the tubular body preferably beginning with the first chamber containing the sample. Pressure may be applied by hand, pistons, or preferably by one or more rollers pressing the deformable tube and the contents of the sealed tube. The rollers may be motorized and controlled by a computer or other control mechanism.

The progression of the roller over the tube creates pressure within the interior of the tube as well as mechanical pressure on the contents of each chamber. The pressure exerted by the roller causes the solution/reagent capsules (or containers) to burst open releasing the contents of the capsule into the chamber coming into contact with the sample or other reagents. Capsules may also have pressure sensitive one way valves that will release the contents of the capsules when exposed to a threshold pressure.

The sequence of release (rupture) of multiple capsules in a given chamber can be controlled by selecting the length and position of the capsules within the chamber. The roller will rupture the capsules with the greatest length first, since they are encountered by the roller first, and shorter length capsules thereafter in one embodiment.

The timing of exposure of the sample to buffers and reagents can also be controlled by manipulation of the rate of progress of the roller over the tubular body, or by advancing the roller to specific locations rupturing the capsules at the appropriate time and for a desired duration according to the sample preparation protocol that is selected for the cartridge.

The membranes that form the chambers and prevent the liquid from entering the neighboring chamber or stage prematurely are preferably pressure sensitive. The membrane will rupture upon exceeding a certain wall pressure (which can be easily controlled by selecting the proper membrane material and wall thickness). Alternatively, in another embodiment the membrane can be ruptured using an optional floatable piercing pin. Rolling the pressure applicator over the chamber will push the chamber's contents (including the floating pin) towards the chamber separation membrane. Upon reaching a certain pressure, the pin penetrates the membrane, thus allowing the contents of the currently active chamber to flow into the next chamber.

Interior pressure within the chambers may also be used to direct fluids through a filter element or catalyst element or the like located in a chamber. Such elements may be permanently attached to the interior of the tube or free floating within a chamber.

In an alternative embodiment, the tubular body is rigid and configured to receive a plunger that advances down the center of the tube. The tubular body is segmented with pressure sensitive membranes forming the desired number of chambers. In one embodiment, a spindle or worm drive is used to control the plunger movement to avoid overshooting or skipping chambers. The plunger engages the reagent capsules causing them to rupture and release their contents into the chamber. In one embodiment, the plunger has a membrane piercing element on the tip that punctures reagent capsules as well as the chamber membranes. In this embodiment, the reagents may be separately contained in capsules or enclosed in cross-sectional membranes enclosing the reagents.

In another embodiment, the sample preparation cartridge is capable of in-line waste removal. In this embodiment, waste chambers are provided that can seperate materials during processing. The preferred waste chambers are filled with a sponge/foam-like material that is capable of absorbing liquid waste. The absorbant material surrounds a perforated main tube that extends through the waste chambers and joins with the next chamber. As the internal plunger pushes the sample material through the waste chamber section, the liquid waste materials escapes the main tube through the perforations and gets absorbed by the waste chamber foam ring.

The cartridges are modular and can be configured to be combined through threaded or other coupling methods. Cartridges with different functionalities can be coupled in the field at the time of collection or to reduce possible exposure to contaminants or cross-contamination. For example, one cartridge may be for a sequence of extraction steps and a second cartridge could be for a sequence of steps that remove inhibitors or other contaminants. Similarly, cartridges can be configured to correspond with individual reaction steps or diagnostic steps that can be tailored to desired combinations of functional steps.

A sample storage container can also be attached to the end of the tubular body to receive the prepared sample for transportation, storage, or further analysis at a remote laboratory.

The system is also easily adapted to automation using programmable controllers and motors to apply pressure to the segments at predetermined times so that reagent bladders and membranes are ruptured in the desired sequence and times. In addition, temperature control elements such as heating or cooling coils can be wrapped around or an integrated part of the tubular body. Visual temperature and pH indicators as well as other probes may also be present.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a schematic side view of an illustrative sample preparation cartridge according to the present invention.

FIG. 2 is a cross-sectional view of the body of the sample preparation cartridge of FIG. 1 taken along the lines 2-2.

FIG. 3 is a schematic side view of a vertical column embodiment of a sample preparation cartridge according to the present invention.

FIG. 4 is a schematic side view of an alternative embodiment of the sample preparation cartridge according to the present invention.

FIG. 5 is a cross-sectional view of the body of the sample preparation cartridge of FIG. 4 taken along the lines 5-5.

### DETAILED DESCRIPTION OF THE INVENTION

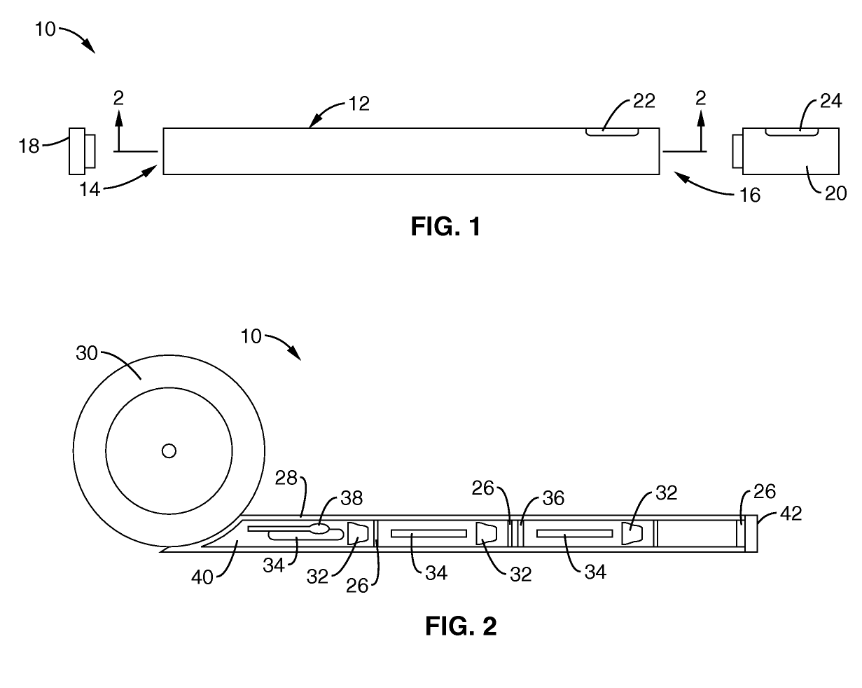

Referring more specifically to the drawings, for illustrative purposes the present invention is embodied in the apparatus generally shown in FIG. 1 through FIG. 5. It will be appreciated that the apparatus may vary as to configuration and as to details of the parts without departing from the basic concepts as disclosed herein.

Generally, the sample preparation cartridge shown in FIG. 1 through FIG. 5 is a low cost, self-contained cartridge that is easy to operate and can be used at the site of sample collection (e.g., in the field or in a doctor's office). It is virtually impossible for the user to mix up or skip steps because the system is closed and the process may be automated.

The system enables laboratory technicians or field investigators to perform a wide variety of biological or chemical sample preparation tasks in the field or laboratory. For example, in one embodiment, the cartridge apparatus and system can be used to perform typical sample preparation tasks such as digestion, dilution, filtration/purification, and extraction without using any external equipment (e.g., pipette, centrifuge, vacuum source) and without using any electricity. Being able to operate this system without the use of any internal/external power source and auxiliary devices makes this embodiment suitable for low-cost, disposable sample preparation field kits.

The apparatus also significantly reduces the number of possible contamination events that can occur during sample processing. For example, existing purification systems require the user to open the sample container to add buffers or other reagents. Repeated container openings create opportunities for sample contamination and operator errors. The need to handle and transfer sample material between devices and containers multiple times can also be avoided, thus increasing quality control significantly. Sample tracking is also simplified with a single sample preparation cartridge that is self contained.

The lower level of required user sophistication, re-configurability of the apparatus, small physical footprint, contamination and error reduction and reduced infrastructure requirements are important advantages of the apparatus.

Turning now to FIG. 1 and FIG. 2, one embodiment 10 of the apparatus is schematically shown. The sample preparation cartridge 10 has a generally tubular body 12 with an open sample intake end 14 and a prepared sample discharge end 16. A sample collected from the field or at a point of care setting such as a hospital or doctor's office can be placed directly in the interior of intake end 14 of the apparatus and a cap 18 may be placed on the intake end 14 to enclose the sample within the interior of body 12.

In the embodiment shown in FIG. 1, an optional storage container 20 can be coupled to the tubular body 12 to receive the sample that is processed within body 12. The container 20 can be secured with a cap and transported to a laboratory for further analysis or for storage.

In another embodiment, container 20 may also contain antibodies or other indicator of the presence of a particular antigen that can give a yes or no answer to the presence toxins, pathogens, or other molecules of interest. This can provide real time results in the field that could protect the health of workers at hazardous waste sites, for example.

Sample identification 22 can be placed on the exterior 26 of body 12 and corresponding identification 24 can be placed on container 20. Matching barcodes are particularly preferred as identification for the body 12 and container 20.

The interior of tubular body 12 is segmented into any number of chambers with membranes 26 covering the cross-section of the interior of the tubular body 12 as shown in FIG. 2. In this embodiment, the wall 28 of body 12 is flexible and capable of being compressed with the application of external pressure from any source. A single roller 30 or a pair of parallel rollers can compress the flexible wall of body 12 to apply pressure on the contents of the body 12 as the roller 30 advances along the length of body 12. Other combinations of rollers or other compressing mechanisms may also be used including compression by hand.

The membranes 26 are made of a material that will rupture with the application of a threshold pressure. Alternatively, the membrane 26 will separate from the interior walls of body 12 with a threshold pressure. A further design alternative for membrane 26 would be a pressure-sensitive valve, such as a one-way duct valve, which would open up automatically once the pressure inside the chamber exceeds a certain pressure level. The rupture of membranes 26 can be assisted with optional piercing pin 32 that has a pointed pin that can pierce the membrane when pressure is exerted on the pin 32 by the contents of the chamber or interior gas pressure forces the piercing pin through the membrane after the pressure exceeds a desired limit.

The membrane barrier 26 will create a stage or reaction area that can be used and then changed with the application of a threshold pressure. The membrane barrier 26 preferably contains one or more bladders or capsules 34 that are filled with buffers and reactants determined by the preparation protocol for a particular type of sample. Although a single capsule 34 is shown in each of the chambers of body 12 shown in FIG. 2, it will be understood that more than one capsule may be present. In addition, capsules may have different lengths and volumes. The capsules 34 can be filled with solid powders, liquids or, gases.

The chambers formed in the interior 40 of body 12 by membranes 26 can also have other elements such as a filter 36 that can filter out unwanted material or excess reactants from the sample. The element could also be a catalyst or a diagnostic, lateral flow test strip.

A sample 38 is placed in the interior 40 of the input end of body 12 in the embodiment shown in FIG. 2. The input end 14 of body 12 can be capped so that the fluids and sample are contained. In one embodiment, the input end 14 of tube 12 is placed in a slot in roller 30 sealing the end and the body 12 is rolled around the roller 30 incrementally through the length of the tubular body 12. In another embodiment, the pressure on the contents of the tube 12 and capsules 34 is applied by hand. In the embodiment of FIG. 2, the sample preparation cartridge 10 is placed on a smooth solid surface and roller 30 is advanced along the length of the body 12, compressing the body and the contents of the body 12. Multiple rollers may also be used.

During use, roller 30, or other pressure applicator, advances along the length of the tube causing the rupture of capsules 34 containing different buffers or reactants. An initial capsule 34 is present in the sample chamber that has a buffer or first fluid called for in an extraction protocol, for example. In one embodiment, the first chamber has a volume of liquid present in the first chamber and the sample is placed directly into the liquid at the time of collection and capped with cap 18.

After the sample 38 is exposed to the contents of the first capsule 34 in the first chamber for a desired period of time, the continued advancement of the roller 30 creates internal pressure that drives the optional piercing pin through membrane 26 causing the membrane to rupture. In another embodiment, the pressure exerted by the liquid on the membrane 26 causes the membrane to rupture, or alternatively causes the membrane 26 to open up or to separate from the interior wall of the tubular body 12 so that the contents of the first chamber enters the second chamber.

Reactants in the second or subsequent chambers can be contained in the chamber or preferably in one or more capsules 34 located in the second chamber. It can be seen that the sequence of exposure to reactants within a chamber can be determined by the length or position of a capsule in the chamber and the number of capsules in the chamber. For example, the first desired exposure to a reactant within a chamber would be in a capsule that encounters pressure from the roller first. Later reactants in the sequence would be in capsules 34 of shorter length and therefore ruptured later in the sequence.

The contents of a chamber may also be directed through filters 36 or other sieves that separate components or solid catalysts and the like as part of the preparation protocol. Depending on the functionality of the element, the element may be permanently attached to the chamber or may be free floating.

The tubular body 12 preferably has a coupling 42 that will permit the body 12 to be connected to a specimen container 20 or to a second tubular body. It will be seen that the cartridges 10 can be configured to contain a wide variety of preparation or analytical steps that can be specific for a particular sample or have general application to types of samples. The modular nature of the cartridges will permit cartridges with different functionalities to be coupled together by the user. Analytical protocols can be changed or modified in the field in response to the types of samples that are being collected. Mixing, filtration, dilution, extraction, heating, cooling, stabilization, and (optionally) in-situ analysis can take place without exposure to contamination through open containers or to operator error.

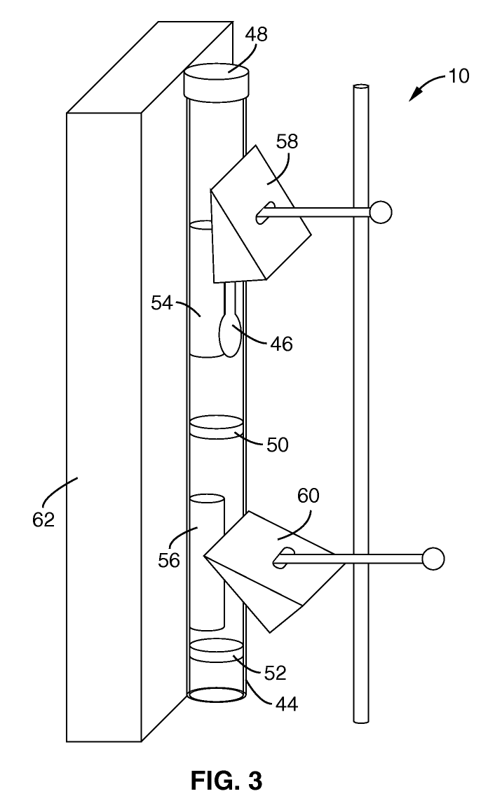

The embodiment shown schematically in FIG. 3 illustrates an alternative to a roller or hand compression of the flexible body of the sample preparation cartridge 10. In this embodiment, the flexible body 44 and its contents are compressed at designated locations with push blocks. The interior of the body 44 is segmented into separate chambers with pressure sensitive membranes 50, 52, that have any number and volume of pressure-sensitive reagent pouches 54, 56.

The body 44 can be pressed between push blocks 58, 60 and a countervailing wall 62. The push blocks 58, 60 are preferably connected to electronically controlled solenoids or linear motors (not shown) that can force the blocks against the tubular body 44 and cause the reagent pouches 54, 56 to burst open and release their contents into the chamber at designated times. In another embodiment, the reagent reservoirs are on the exterior of the body 44 with channels connected to the chamber so that applied pressure forces the liquid from the reservoir to the chamber. Pushing of the blocks in a certain order and at a certain speed and time (e.g., in accordance with a pre-defined, biochemical protocol) could be easily automated by using a simple microcontroller and linear motors or pneumatic valves as actuators.

With the use of push blocks or other knobs or heads to apply pressure on the outside of the sample preparation cartridge, the process can be automated and the apparatus can be reused for other cartridges. By placing the buttons and push blocks into a separate housing or device, the user only needs to drop in the cartridge, which would lower manufacturing costs and permit re-use. In addition, repeated partial compressions by the push blocks 58, 60 can cause the contents of the chamber to be agitated and mixed.

A sample 46 on collection media is placed in the interior of the tubular body 44 and capped with cap 48. The first chamber that receives the specimen 46 can contain one or more capsules 54 as well as solid or liquid reagents. Compression by block 58 will rupture capsule 54 and release the contents of the capsule into the chamber.

By carefully selecting the chamber volume and membrane (e.g., a pressure-sensitive rupture or one-way duct valve), the system can be designed to release the contents of one chamber into the neighboring chamber upon reaching a certain chamber-internal pressure level. For example, in one embodiment, the push block 58 is extended to a first distance to rupture the capsule 54 and a further distance to rupture the membrane separating the chambers. Consequently, the timing and progression of sample and reagents can be controlled. Push block 58 can remain fully extended to keep the tube fully compressed so that the chamber remains closed and backward movement and contamination can be avoided.

Push block 60 extends to rupture capsule 56 and release the reagent to continue the processing of the sample 46. Although only one capsule is shown in FIG. 3 many different capsules can be used. As described previously, mini-filters, catalysts, indicators, heaters and other sample preparation technology scaled for use in the tubular body may also be used. In addition, it will be seen that the apparatus scales easily with respect to size/volume and number of chambers. The apparatus can also be easily expanded to a parallel, multi-tube cartridge to allow for setting up parallel bio-chemical reactions.

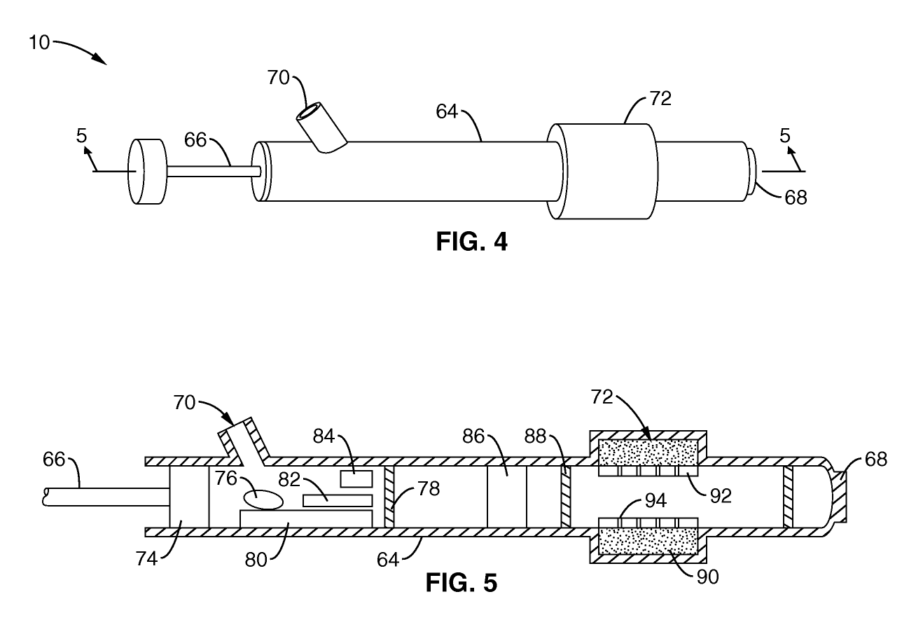

Turning now to FIG. 4 and FIG. 5, an alternative embodiment of the invention 10 is shown that has a rigid tubular body 64 and a central plunger 66. This design is modular, which allows it to be applied to a wide variety of sample preparation protocols. The plunger 66 is preferably advanced through the core of the body 64 with a worm-spindle drive and a stepper motor controlled electronically. This embodiment permits automation of the sample preparation timing and sequence. Another benefit from using an internal push plunger 66, in particular a spindle or worm-drive like plunger configuration, is that it prevents the user from applying too much force on the plunger and potentially overshooting or skipping chambers.

The modular design of the embodiment in FIG. 4 and FIG. 5 can be coupled to a second body, such as a diagnostic sensor (e.g., a dipstick) or to a container with the use of coupling 68. Each cartridge can be configured to have different functionalities according to established or developed protocols or protions of protocols. Coupling of cartridges with different functions will allow the assembly of a customized apparatus in the field providing sample preparation steps directed to a type of specimen. For example, cartridges may be adapted for a single preparation function such as filtration, or may have many preparation steps such as extraction. The apparatus will also essentially eliminate the opportunities for the introduction of contaminants or switching of vials because of the structure and adaptability of the system.

The sample is introduced to the interior of the cartridge through a sample port 70 and the port can be sealed to reduce the possibility of contamination. The sample or sample swab can be introduced directly through the sample port 70 or if a liquid sample introduced through the use of a needle and syringe or pipette. The embodiment shown also has an inline liquid waste drainage chambers 72 to remove liquid wastes.

The plunger 66 has a plunger head 74 that is generally cylindrical or shaped to essentially match the selected shape of the interior of body 64. The plunger head 74 is preferably made of hard rubber or other inert material that will exert pressure on the reagent capsules and membranes located in the interior of the cartridge. In one embodiment, the plunger head creates an air and liquid tight seal around its periphery so that air or liquid could not pass as the plunger head advances. In another embodiment, the plunger head 74 includes a piercing member such as a pin that can assist in puncturing membranes, bladders or capsules of reagents.

After placement of the sample 76 into the first chamber formed in the interior of the tubular body 64 with membrane 78, the plunger is advanced through the chamber until it engages a first reagent capsule 80 causing the capsule to rupture and release its contents into the first chamber in the embodiment shown. Continued movement of the plunger head 74 causes capsule 82 to rupture and later for capsule 84 to rupture. The position and dimensions of the capsules can create a sequence of reagent releases within the chamber. In another embodiment, multiple capsules with similar dimensions are ruptured at the same time by the plunger head 74.

As seen in FIG. 5, the sample 76 and reagents are pushed from the inside with the plunger head 74 until the membrane 78 is ruptured and the contents of the first chamber flow to a second chamber. In one embodiment, the membrane 78 seperates from the interior wall of the body when sufficient pressure is exerted, rather than rupture of the membrane itself.

The lateral force-based material movement from one chamber to the next with a plunger makes the embodiment of FIG. 4 and FIG. 5 particularly suited for inline filtration or catalysis. Liquid material can be forced through a mini-filter or catalyst unit 86 with pressure created by the plunger 74. Pressure sensitive membrane 88 will also rupture (or open up) when a threshold pressure is reached in the embodiment shown. In one embodiment, the mini-filter can be seperated from the body and the filtered material is extracted from the filter for further processing.

Another function that may be called for in a protocol is waste removal. In one embodiment of waste chamber 72, the chamber is filled with an absorbant sponge or foam-like material 90, capable of absorbing liquid waste material. The waste chamber also includes a main tube 92 that extends through the center of the waste chamber and is contiguous with the chambers of body 64. The main tube 92 is perforated with one or more small drainage holes 94 inside the waste chamber containment. As the internal plunger 74 pushes the sample material through the waste chamber section 72, the liquid waste material escapes the main tube 92 through the perforation holes 94 and gets absorbed by the waste chamber foam ring 90. The waste chamber 72 can also be configured as a seperate module that is coupled to a tubular body at the end of body to eliminate and contain wastes that may be hazardous.

Accordingly, the present invention provides a modular, flexible design for a sample preparation and/or analysis cartridge that can be adapted to a wide varity of protocols and types of samples. Many sample preparation steps can be integrated into a single apparatus through cartridge design as well as coupling of cartridges together into a single device.

The apparatus is also easy to use and does not require any specific training or understanding of the processes involved in the sample preparation. Human error can be avoided through the simple linear approach, because the user cannot skip process steps. Cross-contamination is also minimized because the user does not have direct contact with the sample preparation reagents, buffers, filters and test strips.

The apparatus has a variety of potential applications for law enforcement, environmental and military field diagnostics, and point of care. For example, incorporating this technology into DNA-based consumer test kits for pathogens such as influenza, Alzheimers, and HIV, is just one of the many possible applications. Analytical laboratories can also benefit from pre-analytical sample processing and stabilization in the field in preparation for laboratory diagnostics. The apparatus may also be adapted for hospital or medical office use to simplify sample preparation and diagnostics.

The apparatus can also be configured for medical home testing kits and DNA based screening tests where the specimens are collected by a home user and sealed in the cartridge for home or laboratory processing. Such kits would have a reasonable shelf life because the reactants can be contained in inert capsules in the sterile environment of the cartridge.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A sample preparation and analysis apparatus, comprising:
a flexible tubular body with an interior divided into segments by a plurality of membranes configured to receive a sample;
at least one reservoir of a fluid reagent associated with at least one segment configured to release said fluid reagent to the interior of said segment with the application of pressure on said reservoir; and
means for applying pressure sequentially to said segments of the tubular body,
wherein said pressure applied to said tubular body causes the sequential rupture or opening of said membranes from one end of said tubular body to another,
wherein contents of a segment move sequentially from segment to segment.

2. A sample preparation and analysis apparatus as recited in claim 1, wherein said means for applying pressure comprises at least one pressure roller.

3. A sample preparation and analysis apparatus as recited in claim 1, further comprising:
a membrane piercing pin disposed within the interior of each segment adjacent to a membrane configured to pierce the membrane when exposed to increased pressure.

4. A sample preparation and analysis apparatus as recited in claim 1, wherein said reservoir comprises a self-contained vessel that will burst with applied pressure to release the contents of the vessel into the interior of the segment.

5. A sample preparation and analysis apparatus as recited in claim 4, wherein said self-contained vessel contains a solid, a liquid or a gas.

6. A sample preparation and analysis apparatus as recited in claim 1, wherein said segment contains filter media, wherein fluids from the interior of one side of a segment are passed through the filter media to the other side of the segment.

7. A sample preparation and analysis apparatus as recited in claim 1, further comprising:
a waste separation chamber within at least one segment, said chamber having a perforated inner tube and an absorbent outer ring.

8. A modular sample preparation and/or analysis apparatus, comprising:
a tubular module body with an interior and an intake end and an output end;
at least one reactant filled capsule disposed within the interior of said module body adapted to rupture at a first threshold pressure;
a pressure sensitive membrane disposed in the interior cross-section of the tubular module body adapted to rupture at a second threshold pressure; and
a pressure source,
wherein a sample introduced to the interior of said tubular body can be exposed to at least one reactant.

9. A modular sample preparation and/or analysis apparatus as recited in claim 8, further comprising:
a membrane piercing pin disposed within the interior of the module body adjacent to said membrane configured to pierce the membrane when exposed to increased pressure.

10. A modular sample preparation and/or analysis apparatus as recited in claim 8, wherein said pressure source comprises a plunger disposed within the interior of said module body configured to move from said intake end to said pressure sensitive membrane.

11. A modular sample preparation and/or analysis apparatus as recited in claim 10, further comprising:
a motor;
a drive coupled to said plunger; and
a controller.

12. A modular sample preparation and/or analysis apparatus as recited in claim 8, further comprising:
a filter element located within the interior of the module body.

13. A modular sample preparation and/or analysis apparatus as recited in claim 8, further comprising:
a plurality of heating or cooling elements operably connected to said module body configured to increase the temperature of the contents of the module body.

14. A modular sample preparation and/or analysis apparatus as recited in claim 8, further comprising:
means for coupling one modular body with another modular body.

15. A modular sample preparation and/or analysis apparatus as recited in claim 8, further comprising:
a prepared sample storage container or diagnostic assay (e.g., electronic sensor or lateral flow test strip) coupled to the output end of a modular body; and
means for sealing the sample storage container.

16. A modular sample preparation and/or analysis apparatus as recited in claim 8, further comprising:
a plurality of waste chambers coupled to said output end of said module body, said waste chamber comprising:
a housing;
a perforated tube; and
an absorbent material surrounding the perforated tube, said perforated tube and absorbent material disposed within the housing.

17. A sample preparation and/or analysis apparatus, comprising:
a tubular body with an interior and an intake end, an output end and a sample input port;
a plurality of reactant filled capsules disposed within the interior of said tubular body adapted to rupture when compressed;
a plurality of membranes disposed in the interior cross-section of the tubular body;
a membrane piercing member within the interior of the tubular body; and
a plunger slideably engaged with the interior of the tubular body,
wherein movement of said plunger through the interior of the tubular body ruptures the reactant filled capsules and directs the membrane piercing pin sequentially through said plurality of membranes within said tubular body.

18. A sample preparation and/or analysis apparatus as recited in claim 17, further comprising:
a motor;
a drive coupled to said plunger; and
a controller,
wherein the location of said plunger through the interior of said tubular body can be controlled.

19. A sample preparation and/or analysis apparatus as recited in claim 17, further comprising:
a plurality of filter elements located within the interior of the tubular body.

20. A modular sample preparation and/or analysis apparatus as recited in claim 17, further comprising:
a plurality of heating or cooling elements operably connected to said tubular body configured to increase the temperature of the contents of the tubular body.
